(19) United States
(12) Patent Application Publication
(10) Pub. No.: US 2006/0022418 A1
(43) Pub. Date: Feb. 2, 2006

(54) Golf bag having integrated wheels and an extendable handle

(76) Inventor: Charles M. Ortega, Palos Verdes Estates, CA (US)

Correspondence Address: CARR & FERRELL LLP, 2200 GENG ROAD, PALO ALTO, CA, 94303, US

(21) Appl. No.: 11/099,991

(22) Filed: Apr. 5, 2005

Related U.S. Application Data
(63) Continuation of application No. 10/606,405, filed on Jun. 25, 2003, now abandoned.
(60) Provisional application No. 60/391,849, filed on Jun. 25, 2002.

(51) Int. Cl. B62B 1/00

(52) U.S. Cl. 280/47.26; 280/47.131

(57) ABSTRACT

A golf bag is provided which is utilized for easy transportation of golf paraphernalia. The golf bag comprises an enclosure for containing golf products having a top end and a bottom end. An opening exists at the top end for allowing access to the golf products. A base is located at the bottom end. At least one integrated wheel is coupled to the base for providing mobility to the golf bag. An extendable handle is coupled to the opening for providing maneuverability to the golf bag.

### CROSS-REFERENCE TO RELATED APPLICATIONS

This application is a continuation application and claims the priority benefit of U.S. patent application Ser. No. 10/606,405, filed Jun. 25, 2003; U.S. patent application Ser. No. 10/606,405 claims the priority benefit of U.S. provisional patent application No. 60/391,849, filed Jun. 25, 2002. The disclosure of these commonly owned and assigned applications is incorporated herein by reference.

### BACKGROUND OF THE INVENTION

1. Field of the Invention

The present invention relates generally to the field of golf products, and more particularly to a golf bag having integrated wheels and an extendable handle.

2. Background of the Invention

The game of golf traditionally requires that numerous items and paraphernalia associated with the game be transported around a golf course. Generally, these items are transported via a golf bag. Golf bags accordingly encase not only clubs, but often shoes, golf balls, golf gloves, score cards, pens and pencils, cell phones, and a plurality of other items that a golfer desires to keep close at hand during the game.

This assortment of paraphernalia can add considerable weight to what is already a fairly heavy golf bag. Due to the weight of the golf bag, most golf courses provide motorized golf carts for transport. Typically, motorized golf carts include straps on the back for attaching the golf bag thereto. The motorized golf carts are maneuvered on pathways provided therefore, as well as some sections of the course itself. However, these motorized golf carts are generally not allowed on or near a putting green or various other areas of the golf course. Thus, a golfer is forced to unstrap his/her bag and carry the golf bag across a fairway, side of the putting green, or other locations in order to have ready access to a variety of clubs. Otherwise, the golfer can select one or two clubs he/she thinks he/she might use in the areas inaccessible by the golf cart. In this latter case, the golfer often lacks an ideal club for an occasion. Disadvantageously, the former case necessitates a delay in play due to the golfer unstrapping the golf bag, carrying it to a next point of play, returning to the motorized golf cart after play, strapping the golf bag back onto the motorized golf cart, and so forth. Further, the sheer weight of the golf bag may result in a delay in play since it tends to slow down a golfer carrying the heavy golf bag.

As an alternative, golf courses frequently offer wheeled (non-motorized) golf carts for transporting the golf bags. The wheeled golf carts include equipment for attaching the golf bag, and typically include a handle for pulling the golf cart and wheels extending from the cart. Many golfers prefer the wheeled golf carts since walking the golf course during the golfer's round facilitates a cardiovascular workout. Disadvantageously, these manual golf carts are often bulky and clumsy to use. In addition, due to the cardiovascular benefits, some golfers prefer to carry their golf bag for a portion of the round. Since the wheeled golf cart cannot be abandoned on the golf course in favor of carrying the golf bag, nor can it be easily lifted with the golf bag strapped to the wheeled golf cart, the option of carrying the golf bag is eliminated.

Due to the disadvantages of the motorized golf carts and the manual wheeled golf carts, various golf bags have been devised in order to alleviate the problems associated with the aforementioned transport mechanisms. Some devices offer stroller devices for golf bags. Frequently, these stroller-type devices present the same drawbacks as the manual wheeled golf carts. Alternatively, a variety of golf bags offer wheels attached to the golf bag. However, the wheels are generally attached to legs, presenting difficult manipulation to properly deploy the wheeled legs, and an inconvenient option for the golfers who desire to carry their golf bag. Still other golf bags offer handle systems that work to deploy retractable wheels. These golf bags, however, present bulky handles that interfere with carrying. Furthermore, the handles often interfere with space utilized to store the golf clubs within the golf bag, as do the retracted wheels and the axle therebetween. Moreover, these prior art golf bags add considerable weight to the golf bag, thus making the option of carrying the golf bag far less attractive to the golfers.

Recently, suitcases have been developed, which allow for easy transport of the content therein. These suitcases typically include wheels on a bottom end and a handle near a top end. However, these suitcases are not feasible for use with transportation of golf products. Often, the suitcases are too small to accommodate golf clubs. Further, the contents of these suitcases are not easily accessible, often requiring a user to fumble with zippers, locks, latches, and other similar devices. These suitcases also tend to be bulky, heavy, and difficult to manipulate, especially as the size of the suitcase increases.

Travel bags for the transportation of actual golf bags and golf clubs have also been developed. These travel bags frequently include wheels for easy manipulation of the golf bag and golf clubs during travel. Disadvantageously, as with suitcases, the travel bags do not allow easy access to the golf bag and the contents thereof typically encasing the golf clubs. Accordingly, a user must disengage locking mechanisms on the travel bag that prevent the golf bag inside or the golf clubs from escaping the travel bag. Furthermore, travel bags are intended only to protect the golf bag and the golf clubs from damage that may occur during travel. The size, shape, and configuration of the travel bags are not suitable for transporting the contents thereof on an actual golf course. Moreover, many travel bags are extremely heavy due to the fact that the materials of which they are constructed seek to prevent damage, such as punctures, forces that may bend or break golf clubs, etc., to the golf bag and the golf clubs sealed inside the travel bag.

Therefore, it can be appreciated that there exists a continuing need for a new and improved golf bag with integrated wheels that do not interfere with the storage of items in the golf bag or with the carrying of the golf bag. There is a further need for a convenient handle that does not interfere with carrying the golf bag, as well as features that do not add considerable weight to the golf bag.

### SUMMARY OF THE INVENTION

The present invention provides in various embodiments a golf bag, which overcomes prior problems associated with prior art golf bags. The golf bag comprises an enclosure for containing golf products having a top end and a bottom end. An opening exists at the top end for allowing access to the golf products. A base is located at the bottom end. At least one integrated wheel is coupled to the base for providing mobility to the golf bag. An extendable handle is coupled to the opening for providing maneuverability to the golf bag.

In one embodiment, the golf bag comprises an enclosure having a top end and a bottom end for containing golf products. An opening at the top end allows access to golf products. A base is located at the bottom end. An axle is contained within the base, and wheels are affixed to the axle.

A further understanding of the nature and advantages of the inventions herein may be realized by reference to the remaining portions of the specification and the attached drawings.

### BRIEF DESCRIPTION OF THE DRAWINGS

FIG. 1A is a perspective view of one embodiment of a golf bag having integrated wheels and an extendable handle;

FIG. 1B is a perspective view of the extendable handle and a kickstand in accordance with an embodiment of the present invention;

FIG. 2 is a perspective view of an exemplary interior of the golf bag;

FIG. 3 is an exploded perspective view of an exemplary base of the golf bag in accordance with an embodiment of the present invention;

FIG. 4A is a perspective view of a handle design in accordance with an embodiment of the present invention;

FIG. 4B is a perspective view of an alternative embodiment of the golf bag; and

FIG. 5 is a perspective view of the exemplary handle design of FIG. 4 in an extended position.

### DESCRIPTION OF THE EXEMPLARY EMBODIMENTS

As shown in the exemplary drawings wherein like reference numerals indicate like or corresponding elements among the figures, an embodiment of a system according to the present invention will now be described in detail. The following description sets forth an example of an improved golf bag.

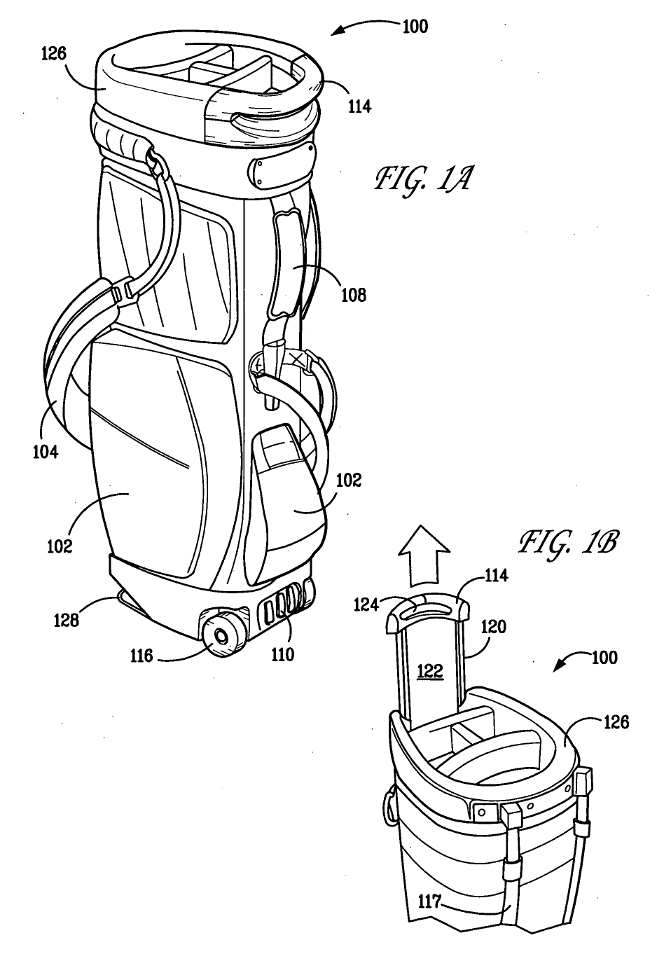

Referring now to FIG. 1A, a perspective view of one embodiment of a golf bag 100 having at least one integrated wheel(s) 116 and an extendable handle 114 is shown. Generally, the golf bag 100 includes various pockets 102 for transporting and storing items. A carrying strap 104 may be attached to the golf bag 100 for over the shoulder carrying of the golf bag 100.

Further, a kickstand (not shown) may be attached to the golf bag 100 at a back side. The kickstand allows for the angled positioning of the golf bag 100, which provides easier access to golf clubs contained within the golf bag 100. A lever 128 that activates the kickstand may be located at or near the bottom of the golf bag 100. The lever 128 typically deploys the kickstand when the golf bag 100 is tilted in such a manner as to depress the lever 128. However, any type of mechanism for activating the kickstand is within the scope of the invention.

A strap handle 108 may be attached to a front side of the golf bag 100 for transport, as is conventional with golf bags. A kick plate 110 is included on the golf bag 100 for simple manipulation of the golf bag 100. For example, a user may apply a force to the kick plate 110 in order to move the golf bag 100 into a mobile position (i.e., balanced on the integrated wheels 116).

The carrying strap 104 may be any type of carrying strap suitable for use with the present golf bag 100. For example, the carrying strap 104 may be a dual strap type, which allows a user to carry the golf bag 100 in a similar manner as a back pack is carried. This provides more stability for the golf bag 100 during transport, and more evenly distributes the weight of the golf bag 100 and the golf bag's contents on the user.

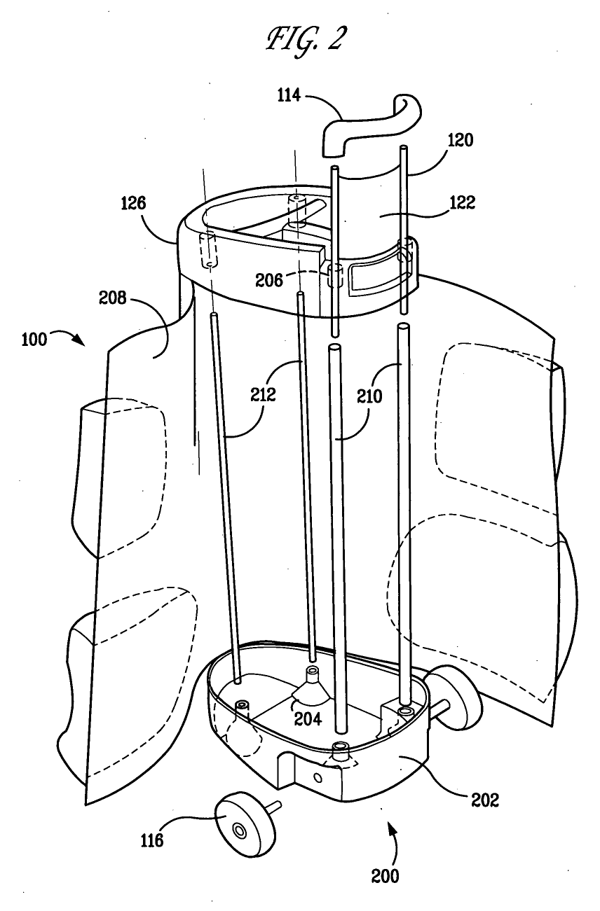

The present golf bag 100 also includes internal front support rails (not shown) for providing stability and for housing the extendable handle 114. The extendable handle 114 slides in and out of these front support rails. Back support rails (not shown), opposite the front support rails discussed above, are also included internally in the golf bag 100. Accordingly, the golf bag 100 internally houses four supporting rails. The internal front and back support rails will be discussed in more detail in connection with FIG. 2.

Further included on the golf bag 100 are the integrated wheels 116. The integrated wheels 116 are attached at a base of the golf bag 100 on either side of the kick plate 110. Alternatively, the integrated wheels 116 may be attached at any area of the base of the golf bag 100 as is suitable with the present invention.

In an exemplary embodiment of the present invention, the integrated wheels 116 are inline skate wheels. Inline skate wheels are typically 50 to 80 millimeters in diameter. Smaller wheels usually provide maneuverability, whereas larger wheels provide more speed. For use with the golf bag 100 of the present invention, smaller inline skate wheels may be utilized, since speed is not required on a golf course, in the golf course parking lot, etc. However, larger wheels may also be employed in order to provide added stability. In alternative embodiments, other forms of wheels may also be utilized. Although inline skate wheels typically do not extend beyond the perimeter of the golf bag, inline skate wheels and other forms of wheels may optionally extend beyond the perimeter of the golf bag. In one embodiment, the integrated wheels 116 are detachable.

In order to ease friction, bearings may be included in the hub of each inline skate wheel. There are a variety of types, sizes, etc. of bearings. Any bearings suitable for use with the inline skate wheels, or any other contemplated wheel types, may be employed. Further, bearing spacers may be utilized with the inline skate wheels. As with the bearings, there are numerous types of spacers. Any type of spacers suitable for use with the inline skate wheels, or any other contemplated wheel types, may be employed.

In another embodiment of the present invention, the integrated wheels 116 may be skateboard type wheels. Skateboard type wheels are typically 55 millimeters in diameter. However, any diameter suitable for use with the present invention may be employed.

Generally, wheels come in a variety of sizes, shapes, colors, profiles, width, and hardness. In particular, the hardness of a wheel is referred to as its durometer. Durometer is measured on a scale from zero to one hundred, with one hundred being the hardest. Durometer is denoted by the suffix “A” (e.g., 80 A). Durometers for inline skate wheels tend to range from 74 A to 96 A, while skateboard wheel durometers tend to range from 78 A to 100 A. A softer wheel may be more suitable for rougher terrain, such as asphalt surfaces for instance. However, harder wheels provide more durability and speed. Any wheel durometer suitable for use with the present invention may be employed.

Although inline skate wheels and skateboard type wheels have been exemplified, any type of wheels suitable for use with the golf bag 100 of the present invention may be employed. Further, any characteristics (i.e., size, shape, color, profile, hardness, width, etc.) associated with wheels may be utilized as is suitable for use with the present invention. Additionally, more or fewer wheels may be utilized in accordance with the present invention.

In use, the user can tilt the golf bag 100 via the extendable handle 114, the strap handle 108, or other area of the golf bag 100 that may be grasped. Further, the user may use the kick plate 110 to assist with moving the golf bag 100 to the tilted position. The extendable handle 114 may be extended prior to or after tilting of the golf bag 100. The extendable handle 114 is then utilized to assist in the transportation of the golf bag 100 (e.g., from a vehicle to a golf course, on the golf course, etc.) by pushing or pulling the golf bag 100 via the extendable handle 114 to place the integrated wheels 116 in motion. The golf bag 100 may be transported in any manner suitable for use with the present invention.

The pockets 102, carrying strap 104, and strap handle 108 may be included as part of the golf bag 100, but are not a necessary part of the invention. One or more of the pockets 102, carrying strap 104, and strap handle 108 may be excluded from the golf bag 100 or additional items added in accordance with the present invention.

Referring now to FIG. 1B, a perspective view of the extendable handle 114 and a kickstand 117 is shown. The extendable handle 114 is housed inside the front support rails. As discussed herein, four supporting rails are included in the golf bag 100, creating a support network for stability. The front and back support rails will be discussed in more detail in connection with FIG. 2. As shown, the extendable handle 114 extends from a rested position on top of the golf bag 100. Extension rails 120 are attached to the extendable handle 114 and protrude from the front support rails. The extendable handle 114 may include a guard 122 for preventing golf clubs from falling through space created between the extension rails 120 and the extendable handle 114 upon extension. The extendable handle 114 itself may include an opening 124, which allows a user to grasp the extendable handle 114. When the extendable handle 114 is not extended, the extendable handle 114 rests flush with a collar 126 of the golf bag 100.

Referring now to FIG. 2, a perspective view of an interior of the golf bag 100 is shown in accordance with an exemplary embodiment of the present invention. The interior of the golf bag 100 includes a base piece 202, attachment pieces 204, connecting elements 206, front support rails 210, and back support rails 212. The integrated wheels 116 may attach to the base piece 202 via any means suitable for use with the present invention. As shown in FIG. 2, the base piece 202 includes areas of indentation for attaching the integrated wheels 116. Typically, the integrated wheels 116 are secured to the base piece 202 utilizing independent axles for each of the integrated wheels 116. However, any method of securing the integrated wheels 116 to the base is within the scope of the invention. For example, the integrated wheels 116 may be secured to the base by screwing the wheel to the base piece 202, mounting the integrated wheels 116 to the base piece 202 via a bolt and a lug nut, mounting the integrated wheels 116 to the base piece utilizing a single common axle, and so on.

The front support rails 210 and the back support rails 212 may be made of any material(s) suitable for use with the present invention. The front support rails 210, which receive the extension rails 120 include an opening wide enough for this receipt. Alternatively, the extension rails 120 may envelope the front support rails 210, so that the extension rails 120 include openings wide enough to cover, or otherwise slide over, the front support rails 210. The back support rails 212, on the opposite side of the golf bag 100, may be of a similar size or a different size as the front support rails 210. The connecting elements 206 are positioned at a top portion of the front support rails 210 for connecting the extension rails 120 to the front support rails 210 to allow for movement of the extension rails 120 therein.

In an alternative embodiment of the present invention, two front support rails 210 for receiving the two extension rails 120 are contemplated. However, in this embodiment, there is only one back support rail. Accordingly, the golf bag 100 of this embodiment only includes three support rails.

A shell 208, which is made of fabric or any other material suitable for use with the present invention, encloses the inner structure that may include a portion of the base piece 202, the front support rails 210, and the back support rails 212, thereby forming a container for golf clubs. A top piece, which may be referred to as the collar 126, resides atop the front support rails 210 and the back support rails 212, and forms a space (e.g., an indented area) for the extendable handle 114 when the extendable handle 114 is in a rested, or otherwise non-extended position.

As previously discussed, the guard 122 may or may not be coupled to the extendable handle 114 structure. One purpose of the guard 122 is to prevent golf clubs from slipping through a space created between the extendable handle 114 and the extension rails 120, the golf clubs possibly posing a hindrance to moving the extendable handle 114 back into the rested (i.e., non-extended) position. The guard 122 may meet the extendable handle 114 and sits flush against the extendable handle 114 or against the ends of the extendable handle 114. Alternatively, the guard 122 may extend only a portion of the way up the extension rails 120, leaving a space between the guard 122 and the extendable handle 114. Where the guard 122 is included, the guard 122 can slide with the extendable handle 114 and the extension rails 120. Thus, the guard 122 is housed within the golf bag 100 when the extendable handle 114 is in the resting position.

The extendable handle 114, as shown in FIGS. 1 and 2 is a flexible crescent shaped handle. However, any extendable handle 114 suitable for use with the present invention may be employed. Advantageously, the extendable handle 114 adds stability to the golf bag 100 assembly due to potential manipulation of the extension rails 120 via the extendable handle 114 when transporting the golf bag 100 in a manner consistent with the present invention. For example, a user rolling the golf bag 100 may compensate for tipping of the golf bag 100 to one side by applying pressure to the extendable handle 114, and thus the extension rails 120, opposite the side where the tipping is occurring. Other contemplated handles may present similar benefits.

The golf bag 100 may include fewer or more support rails than the four support rails (i.e. the front support rails 210 and the back support rails 212) discussed herein. For example, only one front support rail and two back support rails may be included in the golf bag 100. In this embodiment, a single extension rail is moveably connected to the one front support rail in a telescoping manner. In order for such a single extension rail to provide stability via potential manipulation of the golf bag 100 while transporting the golf bag 100 via the integrated wheels 116, the handle on the single extension rail may be curved. For example, the handle may be “u” shaped, like the handle of an umbrella. Such a handle would occupy little space in a niche of the collar 126 of the golf bag 100 carved out. The handle may extend over the lip, or otherwise top edge, of the golf bag 100, being contiguous with the collar 126 of the golf bag 100 when the single extension rail is in a rested position. A release button may also be included for locking and releasing the handle and single extension rail. Any handle suitable for use with the invention may be utilized in accordance with this embodiment.

In an alternative embodiment of the present invention, the front support rails 210, the back support rails 212, the extension rails 120, the extendable handle 114 and optional guard 122 may be located exterior to the shell 208 of the golf bag 100. In such an embodiment, the golf bag 100 is capable of being removed from the extendable handle 114, front support rails 210, and back support rails 212. In addition, the integrated wheels 116 and/or the base piece 202 in such an embodiment may be detachable. Accordingly, the extendable handle 114, the fronts support rails 210 and the back support rails 212 structure, integrated wheels 116, and possibly the base piece 202 may be detached from the golf bag 100, itself. A user may choose to detach the golf bag 100 from the foregoing structures in order to alleviate weight, or the user may simply desire to carry the golf bag 100, conventionally.

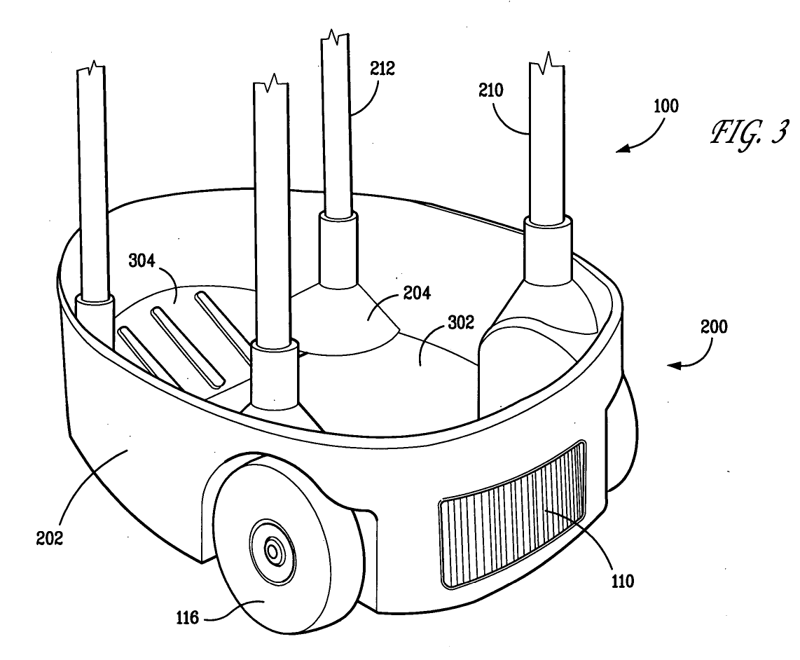

Referring now to FIG. 3, an exploded, perspective view of an exemplary base 300 of the golf bag 100, including the base piece 202, front support rails 210, and back support rails 212 is shown. The base 300 includes the kick plate 110 area and the integrated wheels 116. Further, the base 300 houses the attachment elements 204 for securing the front support rails 210 and the back support rails 212 to the base piece 202. Any placement of the attachment elements 204, the front support rails 210, and the back support rails 212 suitable for use with the present invention may be employed.

The attachment elements 204 shown in FIG. 3 are widened at a bottom portion and narrowed as the attachment elements 204 protrude up from the base piece 202 to meet and enclose the front support rails 210 and the back support rails 212. Any attachment elements 204 suitable for use with the present invention may be utilized. The attachment elements 204 may be flexible to allow for added flexibility of the front support rails 210 and the back support rails 212. Alternatively, the attachment elements 204 may be rigid to reduce or eliminate flexibility of the front support rails 210 and the back support rails 212.

Further, a floor 302 of the base piece 202, as shown in FIG. 3 is generally flat, but includes an elevated portion 304. The elevated portion 304 slopes upward from the flat portion of the floor 302 of the base piece 202. This sloping enables the golf bag 100 to lean in a stable manner when the kickstand 117 (FIG. 1B) is utilized. Alternatively, a larger or smaller elevated portion 304 may be employed. Further, the elevated portion 304 may not be employed at all in the base piece 202, such as, for example, where the golf bag 100 does not include the kickstand 117. Where no elevated portion 304 is included, the floor 302 of the base piece 202 will typically be flat. In another embodiment, more than one elevated portion 304 is included as part of the floor 302 of the base piece 202.

In one embodiment, wheel axles (not shown) are contained within the base piece 202. The wheel axles may comprise a supporting shaft, transverse bar, or member on or with which the one or more wheels 116 revolve. Thus, a single transverse bar or shaft may connect the wheels 116 located on opposing sides of the base piece 202, or each of the at least one wheel 116 may include an axle. The spacing of the wheels 116 in this embodiment may be fixed. As discussed herein, the base piece 202 may include an area of indentation, or recessed area, for housing the wheels 116, such that the wheels 116 do not extend beyond the perimeter of the bag.

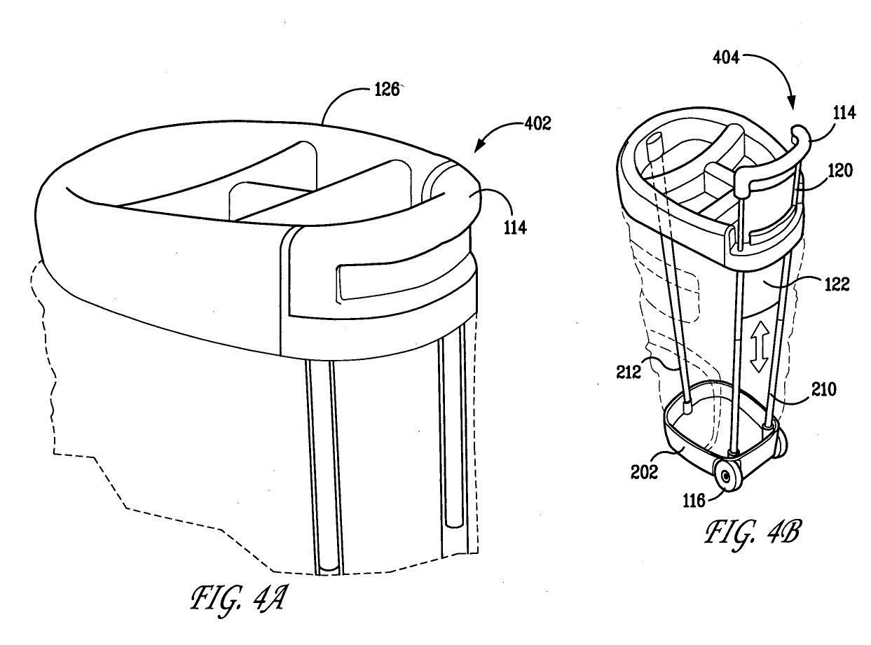

Referring now to FIG. 4A, a perspective view of the extendable handle 114 design is shown. As discussed herein, the extendable handle 114 is crescent shaped and extends between the two extension rails 120 (FIG. 1). Alternatively, any extendable handle 114 suitable for use with the present invention may be utilized. As indicated in FIG. 4A, the extendable handle 114 in a rested position 402 (i.e., 2^{nd} position) sits flush with the collar 126.

Referring now to FIG. 4B, a perspective view of an alternative embodiment of the golf bag 100 is shown. In the embodiment shown in FIG. 4B, two front support rails 210 are shown, while a single back support rail 212 is shown. The single back support rail 212 is attached to the base piece 202 opposite the side of the base piece 202 where the integrated wheels 116 and front support rails 210 are attached. As discussed herein, any number of front support rails 210 and/or back support rails 212 are within the scope of the invention.

Further, FIG. 4B indicates the up and down motions of the extendable handle 114, extension rails 120, and optional guard 122. In one embodiment, the extendable handle 114 extends 13 inches from the golf bag 100. However, the extendable handle 114 may extend any suitable length from the golf bag 100. The extendable handle 114 in FIG. 4B is shown in the extended position 404 (i.e., 1^{st} position).

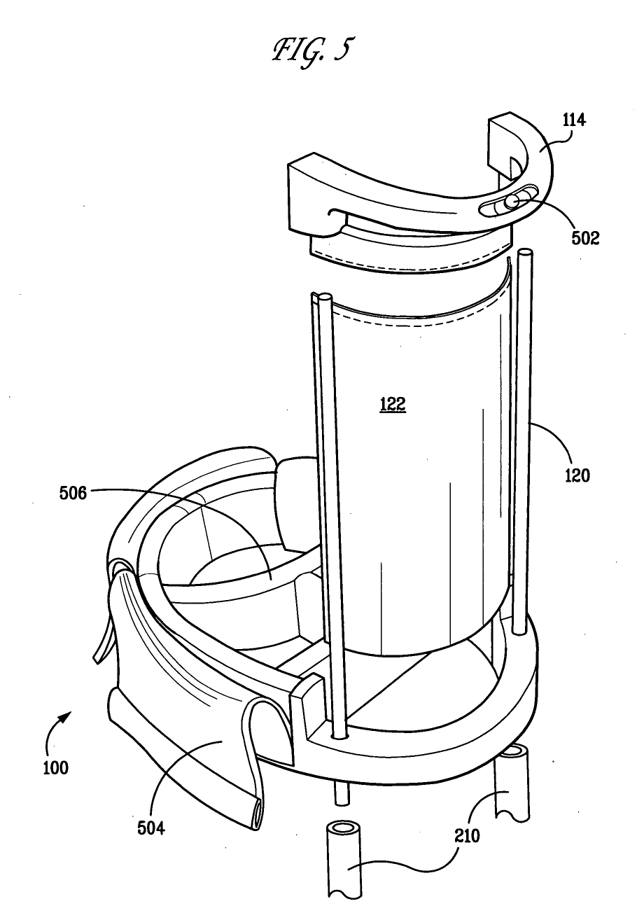

Referring now to FIG. 5, a perspective view of the extendable handle 114 in an extended position is shown. Preferably, the extendable handle 114 may include a release button 502 for releasing the extendable handle 114 from its niche where the extendable handle 114 sits flush with the collar 126 (FIG. 1a). The release button 502 can also lock the extendable handle 114 and extension rails 120 into place when in the extended position. Conversely, when the release button 502 is pressed while the extendable handle 114 is in an extended position, or otherwise activated, the extension rails 120 will slide back into the receptacle of the front support rails 210, and the extendable handle 114 will return to its niche. Thus, the release button 502 is capable of locking the extendable handle 114 while in the rested position, in the extended position, or any position in between. Accordingly, the extendable handle 114 may be locked into various extended positions.

In an alternative embodiment, the release button 502 may be located elsewhere on the golf bag 100. For example, a release button 502 positioned on the top of the collar 126 may release the extendable handle 114. Any positioning of the release button suitable for use with the present invention may be employed.

Beneath the extendable handle 114, the guard 122 may be coupled to the extendable handle 114 and/or the extension rails 120. Any method of coupling may be used that is suitable for use with the present invention. For instance, the guard 122 piece may be sewn to the extendable handle 114 and/or extension rails 120 in some manner. Further, the extension rails 120 may be adapted to receive the guard 122. For example, the extension rails 120 may include openings along the length of the extension rails 120 into which the guard 122 can slide into position. As another example, the extension rails 120 may include snap receivers so that the guard 122 may be snapped onto the extension rails 120. Further, the guard 122 may be made of any material suitable for use with the present invention, such as plastic, leather, etc.

Additionally, the golf bag 100 may include a padded fabric 504 wrapped around the collar 126 (FIG. 1A). Typically, the collar 126 of the golf bag 100 is made of plastic and thus, the collar 126 may be hard and can inadvertently mar golf clubs placed within. Therefore, the collar 126 is preferably padded with the padded fabric 504, but any material(s) suitable for use with the present invention may be utilized to form the collar 126. Further, any type of fabric 504, padded or otherwise, may be provided to wrap around the collar 126 of the golf bag 100.

As shown in the FIG. 5 close-up, as well as in FIGS. 1A, 1B, 2, and 4, separators or dividers 506 may be included in the golf bag 100 at or near the collar 126, or at any other location in the golf bag 100, for separating golf clubs. The dividers 506 may be a single piece or multiple pieces attached to the collar 126, or elsewhere, of the golf bag 100 in any manner consistent with the present invention.

The golf bag 100 of the present invention allows a user to extend the handle and wheel the golf bag 100 from a parking lot to a golf course, on the golf course itself, etc. By virtue of the integrated wheels 116, the golf bag 100 can either be rolled for transportation thereof, or manually carried. Neither the integrated wheels 116 nor the extendable handle 114 add considerable weight, thereby allowing for simple manual carrying of the golf bag 100. Further, due to the negligible weight added to the golf bag 100 by the features discussed herein, the golf bag 100 does not create damage to the golf course beyond the ordinary wear and tear conventional golf bags create. The extendable handle 114 assists with maneuvering the golf bag 100 and allows a user to prevent the golf bag 100 from tipping to one side or the other. The integrated wheels 116, such as the inline skate wheels discussed herein, allow for simple transport and maneuvering of the golf bag 100 on and off of the golf course.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A golf bag, comprising:
an enclosure for containing golf products having a top end and a bottom end;
an opening at the top end for allowing access to the golf products;
a base located at the bottom end;
at least one integrated wheel coupled to the base for providing mobility to the golf bag; and
an extendable handle coupled to the opening for providing maneuverability to the golf bag.

2. The golf bag of claim 1, wherein the at least one integrated wheel is an inline skate wheel.

3. The golf bag of claim 1, wherein the at least one integrated wheel is coupled to the base piece via a bearing and axle system.

4. The golf bag of claim 3, wherein a spacer is utilized with the bearing and axle system to couple the at least one wheel to the base.

5. The golf bag of claim 1, further comprising a kickstand.

6. The golf bag of claim 1, further comprising a release button coupled to the handle for allowing the handle to extend upward from the opening.

7. The golf bag of claim 1, further comprising at least one front support rail.

8. The golf bag of claim 7, further comprising at least one extension rail coupled to the at least one front support rail and to the extendable handle.

9. The golf bag of claim 1, further comprising at least one back support rail.

10. The golf bag of claim 1, further comprising a collar section coupled to the top end of the enclosure.

11. The golf bag of claim 10, wherein the collar section further comprises a cradle section for receiving the extendable handle.

12. The golf bag of claim 1, wherein the at least one integrated wheel is a skateboard wheel.

13. The golf bag of claim 1, wherein the base comprises at least one section that slopes upward.

14. The golf bag recited in claim, further comprising a kick plate located on the base.

15. The golf bag recited in claim 1, wherein the at least one integrated wheel does not extend beyond a perimeter of the golf bag.

16. The golf bag recited in claim 1, wherein spacing of the at least one integrated wheel is fixed.

17. A golf bag, comprising:
a base piece;
a container portion coupled to the base piece for housing of golf paraphernalia;
a plurality of wheels coupled to the base piece for providing mobility to the golf bag; and
an extendable handle coupled to the base piece for providing steerability to the golf bag.

18. The golf bag of claim 17, wherein the base piece further comprises a sloped section.

19. The golf bag of claim 17, further comprising a release button for releasing and locking the extendable handle in a particular position.

20. The golf bag of claim 17, further comprising a guard coupled to the extendable handle for preventing an item from posing a hindrance to a non-extended position of the extendable handle.

21. The golf bag of claim 17, further comprising a cradle section coupled to a top section of the enclosure portion for receiving the extendable handle.

22. The golf bag of claim 17, wherein the plurality of wheels are coupled to the base piece via wheel axles.

23. The golf bag of claim 22, wherein the wheel axles are contained within the base piece.

24. The golf bag of claim 17, wherein the spacing of the plurality of wheels is fixed.

25. The golf bag of claim 17, wherein the plurality of wheels do not extend beyond a perimeter of the golf bag.

26. A golf bag, comprising:
an enclosure for containing golf products having a top end and a bottom end;
an opening at the top end for allowing access to the golf products;
a base located at the bottom end;
an axle coupled to the base;
at least one integrated wheel coupled to the axle for providing mobility to the golf bag;
at least one front support rail coupled to the base;
at least one extension rail coupled to the at least one front support rail;
an extendable handle coupled to the at least one extension rail for providing maneuverability to the golf bag; and
at least one back support rail coupled to the base.

27. A golf bag, comprising:
an enclosure for containing golf products having a top end and a bottom end;
an opening at the top end for allowing access to the golf products;
a base located at the bottom end;
an axle contained within the base; and
at least one wheel affixed to the axle.

28. A golf bag, comprising:
an enclosure for containing golf products having a top end and a bottom end;
an opening at the top end for allowing access to the golf products;
an extendable handle having a guard coupled to the opening;
a base located at the bottom end; and
at least one wheel coupled to the base.
